(19) United States
(12) Patent Application Publication
(10) Pub. No.: US 2025/0014880 A1
(43) Pub. Date: Jan. 9, 2025

(54) Method for Noise Reduction and Ion Rate Estimation Using an Analog Detection System

(71) Applicant: DH Technologies Development Pte. Ltd., Singapore (SG)

(72) Inventors: Gordana IVOSEV, Etobicoke (CA); Nic G. BLOOMFIELD, Newmarket (CA)

(21) Appl. No.: 18/711,346

(22) PCT Filed: Nov. 21, 2022
(86) PCT No.: PCT/IB2022/061220

§ 371 Date: May 17, 2024

Related U.S. Application Data
(60) Provisional application No. 63/264,310, filed on Nov. 19, 2021.

(51) Int. Cl. H01J 49/00; H01J 49/02

(52) U.S. Cl. CPC H01J 49/0036; H01J 49/025

(57) ABSTRACT

Ion intensities measured by an ADC detector subsystem are filtered using equivalent TDC event realizations. In one embodiment, an intensity measurement is received for at least one ion made by an ADC detector subsystem for each of m extractions of an ion beam, producing m intensities for the ion. Equivalent TDC event realizations are received for the ion for each intensity of the m intensities, producing m equivalent TDC event realizations. A filtered intensity for the ion is calculated that is a combination of the m intensities and the m event realizations. In another embodiment, for the ion, an equivalent TDC event realization is accumulated for ion events up to a threshold count of event realizations, N, and the ADC intensities are accumulated for all remaining ion events. A filtered intensity for the ion is calculated that is a combination of the equivalent TDC event realization and the ADC intensities.

### RELATED APPLICATIONS

This application claims the benefit of U.S. Provisional Patent Application Ser. No. 63/264,310, filed on Nov. 19, 2021, the content of which is incorporated by reference herein in its entirety.

### INTRODUCTION

The teachings herein relate to reducing the noise associated with analog-to-digital converter (ADC) detector subsystems at low count rates. More particularly the teachings herein relate to systems and methods for filtering ion intensities measured by an ADC detector subsystem in a time-of-flight (TOF) mass analyzer using equivalent time-to-digital converter (TDC) detector subsystem event realizations derived from the ADC detector subsystem intensities.

The systems and methods herein can be performed in conjunction with a processor, controller, or computer system, such as the computer system of FIG. 1.

### ADC Detector Subsystem Noise

TOF mass spectrometers, such as the ZenoTOF 7600 system produced by SCIEX of Framingham, MA, measure ion peaks using an ADC detector subsystem. Using an ADC detector subsystem, the number of ions in a peak is calculated from the peak signal using a value that relates to the average amplitude of electrical response to a single ion, for example.

Other TOF mass spectrometers measure ion peaks using a time-to-digital converter (TDC) detector subsystem. In a TDC detector subsystem, the ADC detector subsystem is replaced by a constant fraction discriminator (CFD) coupled to a TDC. The CFD removes noise by only transmitting pulses that exceed a threshold value, and the TDC records the time values at which the electrical detection pulses occur. A TDC detector subsystem, therefore, does not record a signal that is proportional to the number of ions hitting the detector at substantially the same time. Instead, a TDC detector subsystem records an event realization only if at least one ion of a particular mass impacts the detector.

A large advantage of ADC detector subsystems is that they can measure ion rates over a significantly larger linear dynamic range than TDC detector subsystems. In mass spectrometry, linear dynamic range is the concentration range over which the signal measured by a mass spectrometer produces a linear response, for example.

One disadvantage of ADC detector subsystems, however, is that they produce significantly higher noise at low measurement frequencies than TDC detector subsystems. For example, the higher noise of ADC detector subsystems results in about a 10% loss in the coefficient of variation (CV) for low-intensity peaks when compared to TDC detector subsystems.

As a result, additional systems and methods are needed to reduce the effects of the higher noise level produced by ADC detector subsystems at low measurement frequencies while maintaining a high linear dynamic range.

### LC-MS and LC-MS/MS Background

Mass spectrometry (MS) is an analytical technique for the detection and quantitation of chemical compounds based on the analysis of mass-to-charge ratios (m/z) of ions formed from those compounds. The combination of mass spectrometry (MS) and liquid chromatography (LC) is an important analytical tool for the identification and quantitation of compounds within a mixture. Generally, in liquid chromatography, a fluid sample under analysis is passed through a column filled with a chemically-treated solid adsorbent material (typically in the form of small solid particles, e.g., silica). Due to slightly different interactions of components of the mixture with the solid adsorbent material (typically referred to as the stationary phase), the different components can have different transit (elution) times through the packed column, resulting in separation of the various components.

Note that the terms “mass” and “m/z” are used interchangeably herein. One of ordinary skill in the art understands that a mass can be found from an m/z by multiplying the m/z by the charge. Similarly, the m/z can be found from a mass by dividing the mass by the charge.

In LC-MS, the effluent exiting the LC column can be continuously subjected to MS analysis. The data from this analysis can be processed to generate an extracted ion chromatogram (XIC), which can depict detected ion intensity (a measure of the number of detected ions of one or more particular analytes) as a function of retention time.

In MS analysis, an MS or precursor ion scan is performed at each interval of the separation for a mass range that includes the precursor ion. An MS scan includes the selection of a precursor ion or precursor ion range and mass analysis of the precursor ion or precursor ion range.

In some cases, the LC effluent can be subjected to tandem mass spectrometry (or mass spectrometry/mass spectrometry MS/MS) for the identification of product ions corresponding to the peaks in the XIC. For example, the precursor ions can be selected based on their mass/charge ratio to be subjected to subsequent stages of mass analysis. For example, the selected precursor ions can be fragmented (e.g., via collision-induced dissociation), and the fragmented ions (product ions) can be analyzed via a subsequent stage of mass spectrometry.

### Tandem Mass Spectrometry or MS/MS Background

Tandem mass spectrometry or MS/MS involves ionization of one or more compounds of interest from a sample, selection of one or more precursor ions of the one or more compounds, fragmentation of the one or more precursor ions into product ions, and mass analysis of the product ions.

Tandem mass spectrometry can provide both qualitative and quantitative information. The product ion spectrum can be used to identify a molecule of interest. The intensity of one or more product ions can be used to quantitate the amount of the compound present in a sample.

A large number of different types of experimental methods or workflows can be performed using a tandem mass spectrometer. These workflows can include, but are not limited to, targeted acquisition, information dependent acquisition (IDA) or data dependent acquisition (DDA), and data independent acquisition (DIA).

In a targeted acquisition method, one or more transitions of a precursor ion to a product ion are predefined for a compound of interest. As a sample is being introduced into the tandem mass spectrometer, the one or more transitions are interrogated during each time period or cycle of a plurality of time periods or cycles. In other words, the mass spectrometer selects and fragments the precursor ion of each transition and performs a targeted mass analysis for the product ion of the transition. As a result, a chromatogram (the variation of the intensity with retention time) is produced for each transition. Targeted acquisition methods include, but are not limited to, multiple reaction monitoring (MRM) and selected reaction monitoring (SRM).

MRM experiments are typically performed using “low resolution” instruments that include, but are not limited to, triple quadrupole (QqQ) or quadrupole linear ion trap (QqLIT) devices. With the advent of “high resolution” instruments, there was a desire to collect MS and MS/MS using workflows that are similar to QqQ/QqLIT systems. High-resolution instruments include, but are not limited to, quadrupole time-of-flight (QqTOF) or orbitrap devices. These high-resolution instruments also provide new functionality.

MRM on QqQ/QqLIT systems is the standard mass spectrometric technique of choice for targeted quantification in all application areas, due to its ability to provide the highest specificity and sensitivity for the detection of specific components in complex mixtures. However, the speed and sensitivity of today's accurate mass systems have enabled a new quantification strategy with similar performance characteristics. In this strategy (termed MRM high resolution (MRM-HR) or parallel reaction monitoring (PRM)), looped MS/MS spectra are collected at high-resolution with short accumulation times, and then fragment ions (product ions) are extracted post-acquisition to generate MRM-like peaks for integration and quantification. With instrumentation like the TRIPLETOF® Systems of AB SCIEX™, this targeted technique is sensitive and fast enough to enable quantitative performance similar to higher-end triple quadrupole instruments, with full fragmentation data measured at high resolution and high mass accuracy.

In other words, in methods such as MRM-HR, a high-resolution precursor ion mass spectrum is obtained, one or more precursor ions are selected and fragmented, and a high-resolution full product ion spectrum is obtained for each selected precursor ion. A full product ion spectrum is collected for each selected precursor ion but a product ion mass of interest can be specified and everything other than the mass window of the product ion mass of interest can be discarded.

In an IDA (or DDA) method, a user can specify criteria for collecting mass spectra of product ions while a sample is being introduced into the tandem mass spectrometer. For example, in an IDA method a precursor ion or mass spectrometry (MS) survey scan is performed to generate a precursor ion peak list. The user can select criteria to filter the peak list for a subset of the precursor ions on the peak list. The survey scan and peak list are periodically refreshed or updated, and MS/MS is then performed on each precursor ion of the subset of precursor ions. A product ion spectrum is produced for each precursor ion. MS/MS is repeatedly performed on the precursor ions of the subset of precursor ions as the sample is being introduced into the tandem mass spectrometer.

In proteomics and many other applications, however, the complexity and dynamic range of compounds is very large. This poses challenges for traditional targeted and IDA methods, requiring very high-speed MS/MS acquisition to deeply interrogate the sample in order to both identify and quantify a broad range of analytes.

As a result, DIA methods, the third broad category of tandem mass spectrometry, were developed. These DIA methods have been used to increase the reproducibility and comprehensiveness of data collection from complex samples. DIA methods can also be called non-specific fragmentation methods. In a DIA method the actions of the tandem mass spectrometer are not varied among MS/MS scans based on data acquired in a previous precursor or survey scan. Instead, a precursor ion mass range is selected. A precursor ion mass selection window is then stepped across the precursor ion mass range. All precursor ions in the precursor ion mass selection window are fragmented and all of the product ions of all of the precursor ions in the precursor ion mass selection window are mass analyzed.

The precursor ion mass selection window used to scan the mass range can be narrow so that the likelihood of multiple precursors within the window is small. This type of DIA method is called, for example, MS/MS^{ALL}. In an MS/MS^{ALL} method, a precursor ion mass selection window of about 1 amu is scanned or stepped across an entire mass range. A product ion spectrum is produced for each 1 amu precursor mass window. The time it takes to analyze or scan the entire mass range once is referred to as one scan cycle. Scanning a narrow precursor ion mass selection window across a wide precursor ion mass range during each cycle, however, can take a long time and is not practical for some instruments and experiments.

As a result, a larger precursor ion mass selection window, or selection window with a greater width, is stepped across the entire precursor mass range. This type of DIA method is called, for example, SWATH acquisition. In a SWATH acquisition, the precursor ion mass selection window stepped across the precursor mass range in each cycle may have a width of 5-25 amu, or even larger. Like the MS/MS^{ALL} method, all of the precursor ions in each precursor ion mass selection window are fragmented, and all of the product ions of all of the precursor ions in each mass selection window are mass analyzed. However, because a wider precursor ion mass selection window is used, the cycle time can be significantly reduced in comparison to the cycle time of the MS/MS^{ALL} method.

U.S. Pat. No. 8,809,770 describes how SWATH acquisition can be used to provide quantitative and qualitative information about the precursor ions of compounds of interest. In particular, the product ions found from fragmenting a precursor ion mass selection window are compared to a database of known product ions of compounds of interest. In addition, ion traces or extracted ion chromatograms (XICs) of the product ions found from fragmenting a precursor ion mass selection window are analyzed to provide quantitative and qualitative information.

However, identifying compounds of interest in a sample analyzed using SWATH acquisition, for example, can be difficult. It can be difficult because either there is no precursor ion information provided with a precursor ion mass selection window to help determine the precursor ion that produces each product ion, or the precursor ion information provided is from a mass spectrometry (MS) observation that has a low sensitivity. In addition, because there is little or no specific precursor ion information provided with a precursor ion mass selection window, it is also difficult to determine if a product ion is convolved with or includes contributions from multiple precursor ions within the precursor ion mass selection window.

As a result, a method of scanning the precursor ion mass selection windows in SWATH acquisition, called scanning SWATH, was developed. Essentially, in scanning SWATH, a precursor ion mass selection window is scanned across a mass range so that successive windows have large areas of overlap and small areas of non-overlap. This scanning makes the resulting product ions a function of the scanned precursor ion mass selection windows. This additional information, in turn, can be used to identify the one or more precursor ions responsible for each product ion.

Scanning SWATH has been described in International Publication No. WO 2013/171459 A2 (hereinafter “the '459 Application”). In the '459 Application, a precursor ion mass selection window or precursor ion mass selection window of 25 Da is scanned with time such that the range of the precursor ion mass selection window changes with time. The timing at which product ions are detected is then correlated to the timing of the precursor ion mass selection window in which their precursor ions were transmitted.

The correlation is done by first plotting the mass-to-charge ratio (m/z) of each product ion detected as a function of the precursor ion m/z values transmitted by the quadrupole mass filter. Since the precursor ion mass selection window is scanned over time, the precursor ion m/z values transmitted by the quadrupole mass filter can also be thought of as times. The start and end times at which a particular product ion is detected are correlated to the start and end times at which its precursor is transmitted from the quadrupole. As a result, the start and end times of the product ion signals are used to determine the start and end times of their corresponding precursor ions.

### SUMMARY

A system, method, and computer program product are disclosed for filtering ion intensities measured by an ADC detector subsystem, in accordance with various embodiments. An intensity measurement is received for at least one ion made by an ADC detector subsystem for each of m extractions of an ion beam, producing m intensities for the ion. A total of m event realizations are received for the ion. For each intensity of the m intensities, an event realization of 1 is produced for an intensity greater than an intensity threshold and an event realization of less than 1 is produced for an intensity less than or equal to the filtered intensity threshold, producing the m event realizations. A filtered intensity is calculated for the ion that is a combination of the m intensities and the m event realizations.

Also, a system, method, and computer program product are disclosed for filtering in real-time ion intensities measured by an ADC detector subsystem, in accordance with various embodiments. An intensity measurement Iᵢ is received for at least one ion made by an ADC detector subsystem for each ith extraction of m extractions of an ion beam. For each Iᵢ of the ion from i=0, if Iᵢ is greater than an intensity threshold, a total count of event realizations, T, is incremented by 1 until T equals a threshold count of event realizations, N, at an extraction, k, optionally where initially T=0. Each Iᵢ from i=k+1 to i=m is added, producing summed intensity Iₛᵤₘ. A filtered intensity is calculated for the ion that is a combination of T and Iₛᵤₘ.

These and other features of the applicant's teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary plot showing how the relative frequency of single ion strikes versus pulse height follows a negative binomial or Polya distribution, in accordance with various embodiments.

FIG. 3 is an exemplary plot showing how the relative frequency of multi-ion strikes versus pulse height follows a convolution of separate negative binomial distributions, in accordance with various embodiments.

FIG. 4 is an exemplary diagram of a TOF mass spectrometry system showing the ions entering a TOF tube, upon which embodiments of the present teachings may be implemented.

FIG. 5 is a plot of sub-spectra received by the processor of FIG. 4 for a series of m extractions, upon which embodiments of the present teachings may be implemented.

FIG. 6 is a plot of the ADC spectrum produced by the processor of FIG. 4 from summing the m sub-spectra of FIG. 5, upon which embodiments of the present teachings may be implemented.

FIG. 7 is an exemplary plot showing a mass spectrum with both unfiltered peaks measured using an ADC detector subsystem and filtered versions of the same peaks using a combination of ADC and equivalent TDC event realizations, in accordance with various embodiments.

FIG. 8 is an exemplary flowchart showing a method for filtering ion intensities measured by an ADC detector subsystem, in accordance with various embodiments.

FIG. 9 is a schematic diagram of a system that includes one or more distinct software modules that and performs a method for filtering ion intensities measured by an ADC detector subsystem, in accordance with various embodiments.

FIG. 10 is an exemplary plot of sub-spectra produced in a system to filter in real-time ion intensities measured by an ADC detector subsystem, in accordance with various embodiments.

FIG. 11 is an exemplary flowchart showing a method for filtering in real-time ion intensities measured by an ADC detector subsystem, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

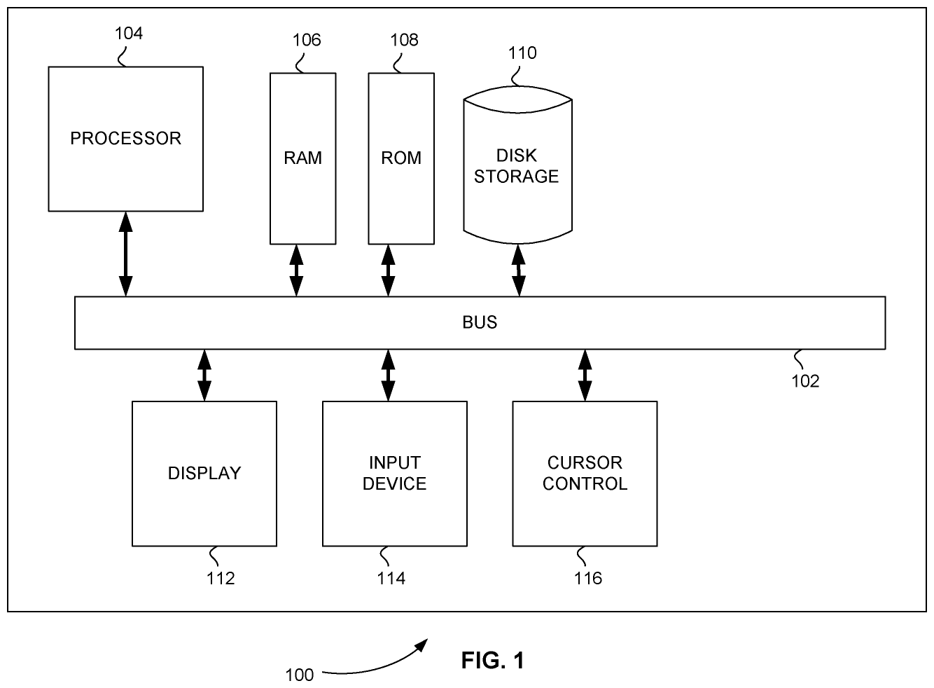

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random-access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively, hard-wired circuitry may be used in place of or in combination with software instructions to implement the present teachings. Thus, implementations of the present teachings are not limited to any specific combination of hardware circuitry and software.

The term “computer-readable medium” or “computer program product” as used herein refers to any media that participates in providing instructions to processor 104 for execution. The terms “computer-readable medium” and “computer program product” are used interchangeably throughout this written description. Such a medium may take many forms, including but not limited to, non-volatile media, volatile media, and precursor ion mass selection media. Non-volatile media includes, for example, optical or magnetic disks, such as storage device 110. Volatile media includes dynamic memory, such as memory 106.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

Filtering Ion Intensities from an Adc Detector Subsystem

As described above, TOF mass spectrometers, such as the ZenoTOF 7600 system produced by SCIEX of Framingham, MA, measure ion peaks using an ADC detector subsystem. Other TOF mass spectrometers measure ion peaks using a time-to-digital converter (TDC) detector subsystem.

A large advantage of ADC detector subsystems is that they can measure ion rates over a significantly larger linear dynamic range than TDC detector subsystems. One disadvantage of ADC detector subsystems, however, is that they produce significantly higher noise at low measurement frequencies than TDC detector subsystems.

More specifically, ADC detector subsystems rely on a linear relationship between the number of ions hitting the detector and the generated analog signal strength (typically an electrical signal pulse is generated, and the pulse height (mV) is measured). As a result, coincidental ion arrivals can be detected using an ADC detector subsystem.

While the relation between the number of ions hitting the detector and the generated analog signal strength is statistically linear, the actual detector gain is a probabilistic process. Consequently, the measured pulse height from an ion strike falls within some uncertainty interval. In other words, the number of ions hitting the detector is linearly correlated with the mode of the detector gain distributions and an uncertainty interval is related to the width of the distribution.

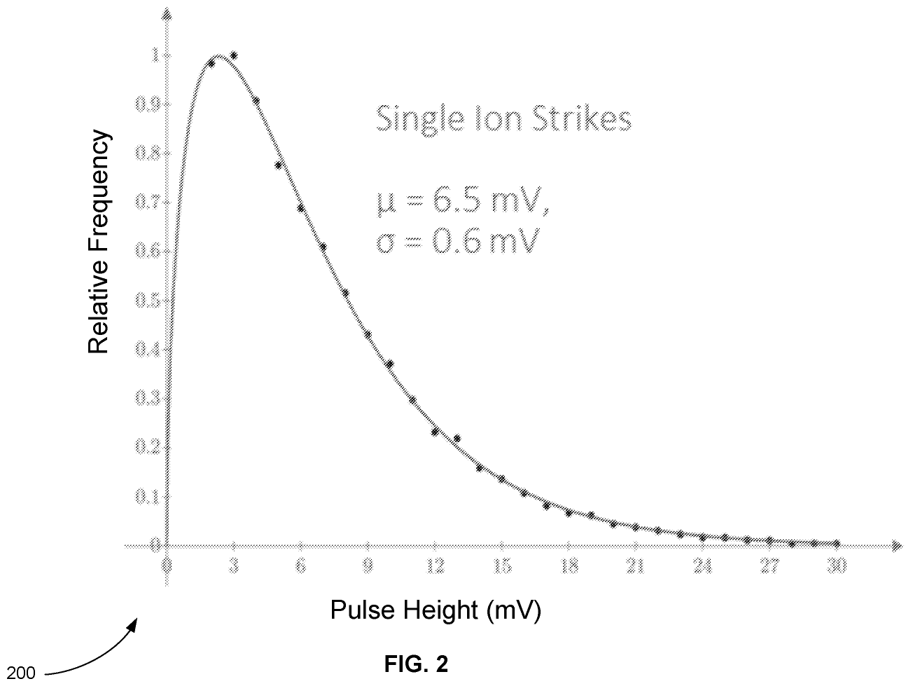

FIG. 2 is an exemplary plot 200 showing how the relative frequency of single ion strikes versus pulse height follows a negative binomial or Polya distribution, in accordance with various embodiments.

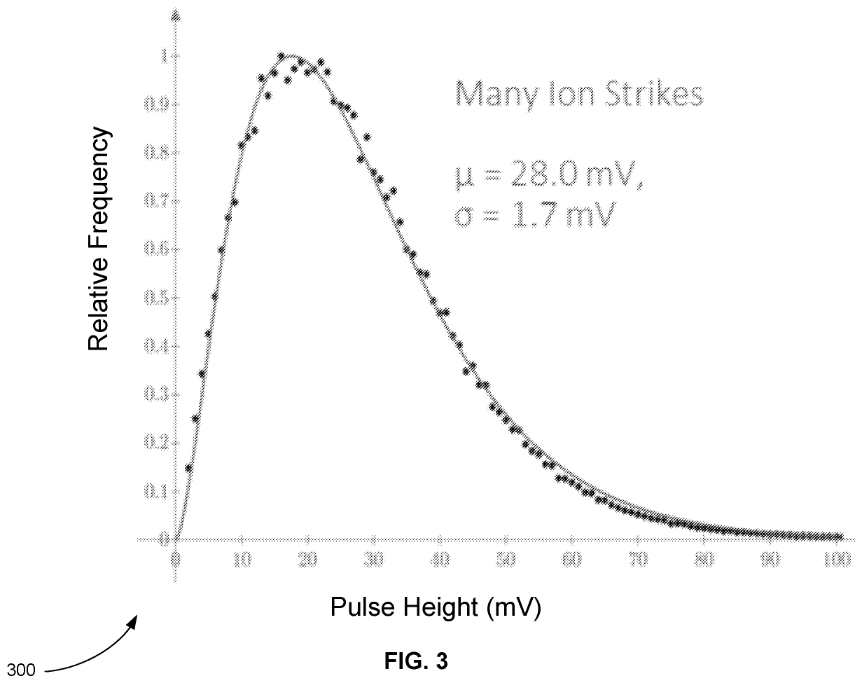

FIG. 3 is an exemplary plot 300 showing how the relative frequency of multi-ion strikes versus pulse height follows a convolution of separate negative binomial distributions, in accordance with various embodiments.

A single instance of charge propagating through the detector that results in multiple instances of charge at the output can be expressed in the following form:

$$P ( g , \overline{g} , σ ) = \frac{{( σ + 1 )}^{( σ + 1 )}}{γ ( σ + 1 )} \frac{{g}^{σ}}{g} {e}^{( - ( σ + 1 ) \frac{g}{g} )}$$

where g, g̅, and σ represent the gain (e.g., in pulse height, average gain, and variance of the distribution, respectively, and γ(σ+1) is the gamma function evaluated at σ+1. The measured pulse height distribution can be fit using the Polya distribution to determine the average pulse height and variance of the distribution.

The width of a single ion response distribution is typically larger than the distance between the most likely responses (distribution apexes) of the single and multiple coincidental ion arrivals at the detector. This means that a single measurement of a single ion can produce a larger response than a single measurement of multiple ions. In a TOF mass spectrometer, such measurements occur many times within a single spectrum acquisition. Since the resulting spectrum is a sum of all TOF pulse sub spectra, the relatively large uncertainty interval associated with a particular m/z is reduced by the square root of the number of ion events (number of TOF pulses when one or more ions of a corresponding m/z are measured). This uncertainty interval can be represented using the root mean square error (RMSE) definition as shown below.

$$RMSE = \sqrt{{\sum }_{i = 1}^{n} \frac{{( {\hat{y}}_{ι} - {y}_{i} )}^{2}}{n}} ,$$

where n is the number measurements, ŷᵢ is an average of all measurement intensities (estimated ion rate), and yᵢ is the true ion rate.

The number of corresponding ion measurements within a spectrum accumulation time depends on the TOF pulse frequency and accumulation time duration as well as the ion rate in event realizations per second or event realizations per second (cps). For a given set of acquisition parameters, the number of ion events follows a Poisson process with the expected rate of occurrences, λ, representing the ion rate per second. At low measurement frequencies, only one or a few ion events will occur, resulting in a large measurement deviation from the expected or most likely response for the corresponding ion rate. As the number of measurements increases, this deviation becomes negligible.

Practically, a single ion event can be recorded in the spectrum with an intensity equivalent to 1, 2, or even 10 ions, with a decreasing probability according to the binomial low. Since there are often many m/z values with a single ion event, spectra can appear very noisy. This noise propagates across the sequential spectra resulting in increased chromatographic noise as well. This increased noise affects spectral and XIC processing algorithms.

In contrast, when a TDC detector subsystem is used, single-ion noise can be effectively removed by thresholding. For example, single-ion noise can have an intensity greater than the intensity of multiple ions.

As a result, additional systems and methods are needed to reduce the effects of the higher noise level produced by ADC detector subsystems at low measurement frequencies while maintaining a high linear dynamic range.

### Equivalent TDC Detector Subsystem Event Realizations

In various embodiments, ion intensities measured by an ADC detector subsystem are filtered using equivalent TDC detector subsystem event realizations derived from the ADC detector subsystem intensities. Equivalent TDC event realizations have been calculated from ADC intensities before. For example, U.S. Pat. No. 9,514,912 (hereinafter the “'912 Patent”) describes using an ADC detector subsystem to produce a response equivalent to a TDC response.

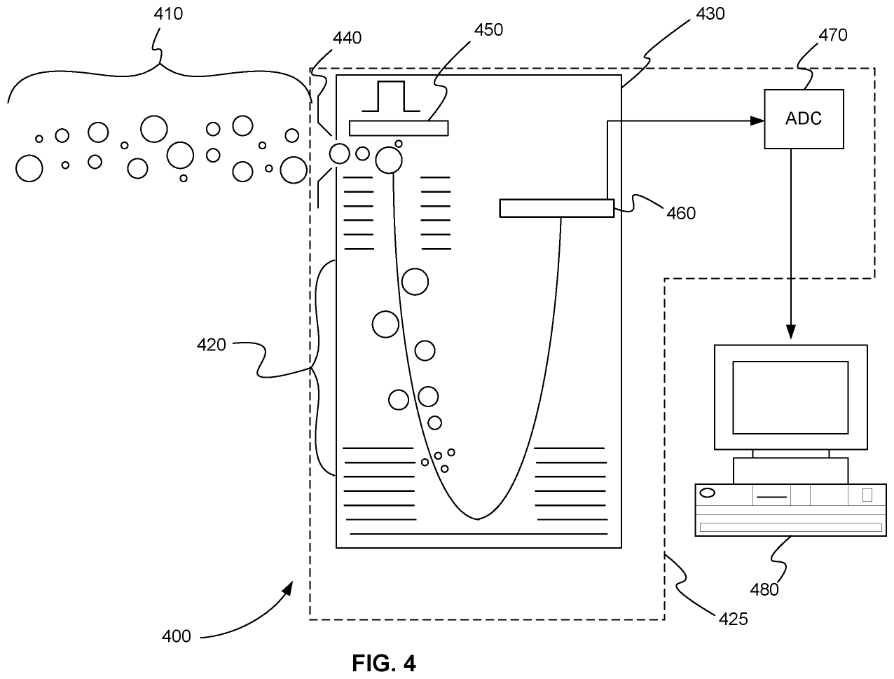

FIG. 4 is an exemplary diagram of a TOF mass spectrometry system 400 showing ions 410 entering TOF tube 430, upon which embodiments of the present teachings may be implemented. TOF mass spectrometry system 400 includes TOF mass analyzer 425 and processor 480. TOF mass analyzer 425 includes TOF tube 430, skimmer 440, extraction device 450, ion detector 460, and ADC detector subsystem 470. Skimmer 440 controls the number of ions entering TOF tube 430. Ions 410 are moving from an ion source (not shown) to TOF tube 430. The number of ions entering TOF tube 430 can be controlled by pulsing skimmer 440, for example.

Extraction device 450 imparts a constant energy to the ions that have entered TOF tube 430 through skimmer 440. Extraction device 450 imparts this constant energy by applying a fixed voltage at a fixed frequency, producing a series of extraction pulses, for example. Because each ion receives the same energy from extraction device 450, the velocity of each ion depends on its mass. According to the equation for kinetic energy, velocity is proportional to the inverse square root of the mass. As a result, lighter ions fly through TOF tube 430 much faster than heavier ions. Ions 420 are imparted with a constant energy in a single extraction but fly through TOF tube 430 at different velocities.

Time is needed between extraction pulses to separate the ions in TOF tube 430 and detect them at ion detector 460. Enough time is allowed between extraction pulses so that the heaviest ion can be detected.

Ion detector 460 generates an electrical detection pulse for every ion that strikes it during an extraction. These detection pulses are passed to ADC detector subsystem 470, which records the amplitudes of the detected pulses digitally. In a TDC detector subsystem, for example, ADC detector subsystem 470 is replaced by a constant fraction discriminator (CFD) coupled to a TDC. The CFD removes noise by only transmitting pulses that exceed a threshold value, and the TDC records the time values at which the electrical detection pulses occur.

Processor 480 receives the pulses recorded by ADC detector subsystem 470 during each extraction. Because each extraction may contain only a few ions from a compound of interest, the responses for each extraction can be thought of as a sub-spectrum. In order to produce more useful results, processor 480 can sum the sub-spectra of time values from a number of extractions to produce a full spectrum.

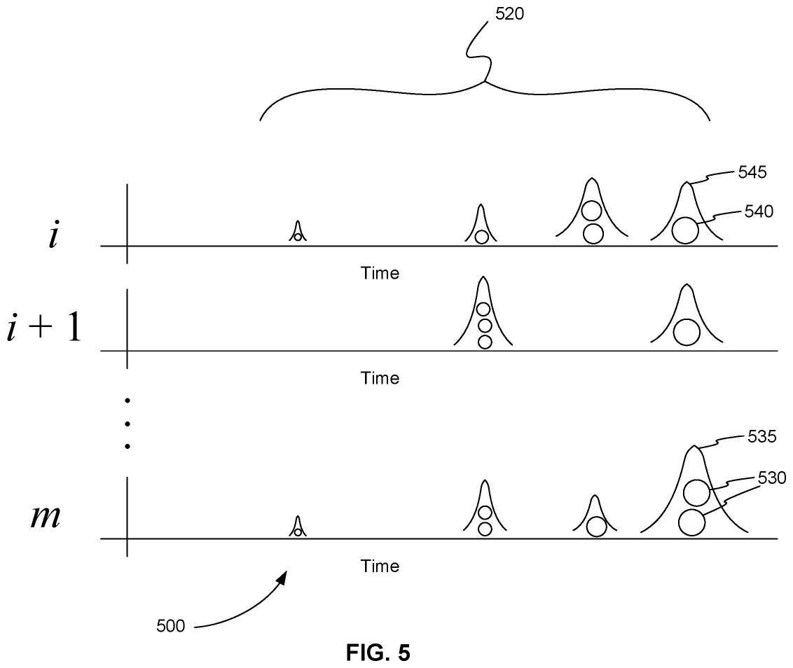

FIG. 5 is a plot of sub-spectra 500 received by processor 480 of FIG. 4 for a series of m extractions, upon which embodiments of the present teachings may be implemented. Sub-spectra for extractions i through m include time values for each ion detected. The horizontal position of each ion in each sub-spectrum represents the time it takes that ion to be detected relative to the extraction pulse. Ions 520 of extraction i in FIG. 5 correspond to ions 420 in FIG. 4, for example.

As shown in sub-spectra 500 of FIG. 5, an ADC produces an amplitude response that is dependent on the number of ions hitting the detector at substantially the same time. For example, the two ions 530 in extraction m produce amplitude response 535 that is larger than amplitude response 545, which is produced by a single ion 540 in extraction i. In other words, the response that an ADC produces is proportional to the number of ions hitting the detector at substantially the same time.

A TDC, on the other hand, does not record a signal that is proportional to the number of ions hitting the detector at substantially the same time. Instead, a TDC records only if at least one ion of a particular mass impacted the detector.

TDC information, however, can be determined from ADC information. For example, in sub-spectra 500 of FIG. 5, a processor, such as processor 480 of FIG. 4, can count the impact of the two ions 530 as a single ion hit for extraction m. In other words, for every extraction, in addition to the ADC response, a single hit is recorded for any amplitude response for a given mass above a certain threshold. This produces a response equivalent to a TDC response.

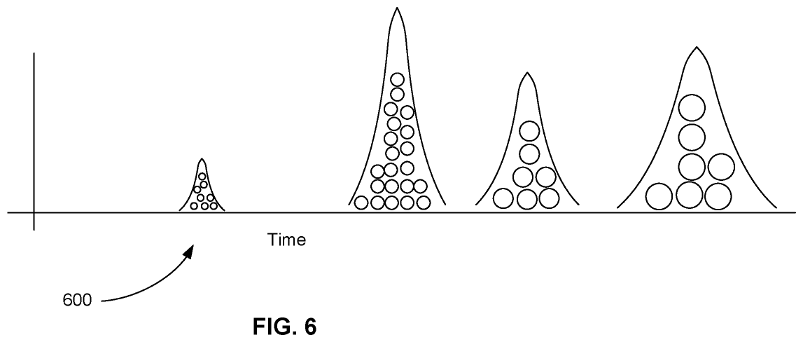

FIG. 6 is a plot of the ADC spectrum 600 produced by processor 480 of FIG. 4 from summing the m sub-spectra of FIG. 5, upon which embodiments of the present teachings may be implemented. Spectrum 600 includes ions of four different masses or m/z values, for example.

### Combining ADC and TDC Event Realizations to Filter

In one embodiment, ADC intensities and equivalent TDC event realizations are acquired and stored. The intensities and event realizations are then combined in an optimal statistical manner to filter the measurements made by the ADC detector subsystem.

For example, the TDC spectrum and the ADC spectrum can be combined as a sum of the two that results in an equivalent TDC noise level at low measurement frequencies and an ADC linear dynamic range for high ion rates, where the ADC noise level (as measured by the RMSE) is negligible.

### Accumulating TDC Event Realizations to the Nth Ion Event Filter

In another alternative embodiment, for each m/z, an equivalent TDC event realization is accumulated for ion events up to a threshold count of event realizations, N. At the Nth ion event, the TOF pulse index is stored as metadata and the ADC intensities are accumulated for all remaining ion events. For example, an ADC detector subsystem measures an intensity, Iᵢ, for at least one ion (or m/z value) for occurrences each ith extraction of m extractions of an ion beam and an equivalent TDC event realization, T, is calculated for the ion (or m/z value) until T equals the threshold count of event realizations, N, at an extraction, k.

In various embodiments, the value of N is the number of ion events that, for a given accumulation time and pulse frequency, ensures that the probability of coincidental ion arrivals at the corresponding m/z is practically zero.

The value of N can be determined from the TOF pulse frequency and accumulation time (number of ion event observations or TOF extraction pulses, m, within the accumulation time), for example. The threshold count of event realizations, N, must be less than m so that the RMSE of the ADC accumulation time period can be kept at the desired level.

Accumulating an equivalent TDC event realization for ion events up to a threshold count of event realizations, N, ensures that equivalent TDC event realizations are used at low ion rates where noise in ADC intensities is of the highest concern. If the threshold count of event realizations, N, is reached for an m/z value and the intensities from all additional intensities, Iᵢ, from i=k+1 to i=m, for that m/z value are added producing intensity Iₛᵤₘ, then the resulting intensity Iₛᵤₘ is possibly lower than it would be if all ion events from i=1 to i=m, included with intensity Iᵢ,

In other words, Iₛᵤₘ is underestimating the number of ions because there might be multiple ion arrivals within at least some of the first N ion events but they were counted as 1 ion. In various embodiments, a correction is applied for those “losses” or otherwise, the isotope ratios will be incorrect or the upper limit of the instrument dynamic range will be reduced (would look like saturation while it is just due to this uncorrected underestimate).

Note that N is an event realization and Iₛᵤₘ is a combination of event realizations, N, and intensities (Iᵢ). In this case, an analog intensity correction is needed for the possible coincidental ion arrivals counted as 1 within the first N events. The count N can be converted to an ADC intensity by multiplying by a calculated ADC average intensity. This analog intensity correction can be expressed as (Iₛᵤₘ−N)/(m−k)*m.

If the threshold count of event realizations, N, is not reached or is reached during the last extraction (T<N or k=m) for an m/z value, then the filtered intensity is the equivalent TDC event realization, T. In this case, a Poisson correction is needed for the possible coincidental ion arrivals. This Poisson correction can be expressed as −log(1−T/m).

If N is such that the probability of coincidental arrivals within m extraction pulses is negligible (N/m<<0.5), no correction is needed since those were most likely single in events.

In either this embodiment or the embodiment in which ADC and equivalent TDC event realizations are combined in an optimal statistical manner, linear dynamic range is preserved without any compromise.

### Results

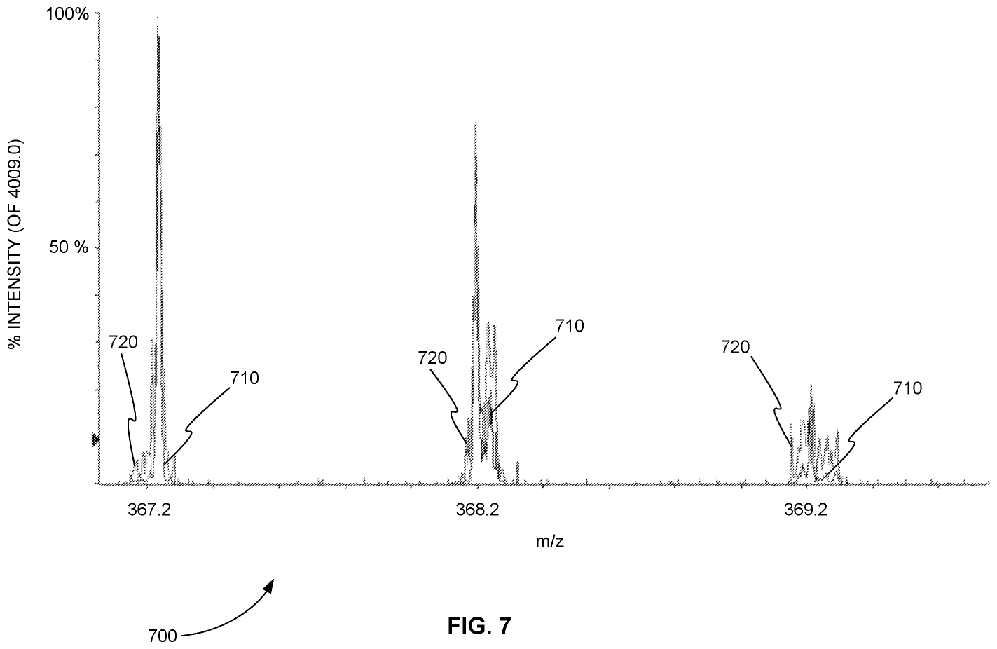

FIG. 7 is an exemplary plot 700 showing a mass spectrum with both unfiltered peaks measured using an ADC detector subsystem and filtered versions of the same peaks using a combination of ADC and equivalent TDC event realizations, in accordance with various embodiments. In plot 700, three filtered peaks 710 are plotted along with three unfiltered peaks 720. A comparison of filtered peaks 710 and unfiltered peaks 720 in plot 720 shows that filtering using a combination of ADC and equivalent TDC event realizations can reduce the noise of peaks in a mass spectrum.

Although, as described above, the '912 Patent discloses producing a response equivalent to a TDC response, the '912 Patent does not teach or suggest using an equivalent TDC response to filter an ADC response using a combination of ADC and TDC event realizations.

Instead, the '912 Patent discloses simultaneously recording an equivalent of a TDC response with every ADC response. From the TDC equivalent response, a Poisson distribution is used to determine the probability that the response is produced by one ion. If the probability is above a certain threshold, then the response is considered to be from a single ion hitting the detector at any one time, and the ratio of the response to the number of ions for that single ion is used in calculating the correction factor. The intensities of a measured spectrum are then multiplied by the correction factor to produce a corrected measured spectrum that has been corrected for uniform detector saturation.

Thus, the '912 Patent differs from the embodiments described herein in that it does not combine ADC and TDC responses to provide a filtered measured response. Instead, the '912 Patent calculates a correction factor for single ion events and applies the correction factor when these events occur. Also, the '912 Patent differs from the embodiments described herein in that it is directed to correcting uniform detector saturation while the embodiments described herein are directed to reducing the noise at low measurement frequencies.

### System for Combining ADC and Equivalent TDC Responses

Returning to FIG. 4, system 400 is used to filter ion intensities measured by an ADC detector subsystem, in accordance with various embodiments. System 400 includes TOF mass analyzer 425 and processor 480. TOF mass analyzer 425 further includes ADC detector subsystem 470.

In system 400, processor 480 receives an intensity measurement for at least one ion made by ADC detector subsystem 470 for each of m extractions of an ion beam, producing m intensities for the ion. Processor 480 can receive an intensity measurement for each of m extractions in real-time during acquisition or can receive the intensities for the m extractions in a post-processing step after acquisition.

Also, one of ordinary skill in the art understands that receiving intensity measurements for at least one ion is also equivalent to receiving intensity measurements for a single m/z value. In other words, the terms “at least one ion” and “a single m/z value” are interchangeable as used herein.

Processor 480 receives m event realizations for the ion. These m event realizations for the ion are equivalent TDC event realizations where, for each intensity of the m intensities, an event realization of 1 is produced for an intensity greater than an intensity threshold and an event realization of less than 1, preferably 0 is produced for an intensity less than or equal to the filtered intensity threshold, producing the m event realizations. Processor 480 can receive the m event realizations from another processing device, TOF mass analyzer 425, or other device. Processor 480 can also calculate the m event realizations itself, store the m event realizations in a memory device (not shown), and receive the m event realizations from the memory device, for example.

Processor 480 calculates a filtered intensity for the ion that is a combination of the m intensities and the m event realizations. The m event realizations can be converted to an intensity before being combined with the m intensities, for example, by multiplying the m event realizations by a predetermined average intensity.

In various embodiments, the filtered intensity is calculated as a weighted sum of the m intensities and the m event realizations.

In various embodiments, when an ion rate of the ion is less than or equal to a threshold rate, a weight applied to the m event realizations is higher than a weight applied to the m intensities to reduce noise.

In various embodiments, when the ion rate of the ion is greater than the threshold rate, the weight applied to the m event realizations is lower than the weight applied to the m intensities to increase dynamic range.

In various embodiments, the threshold rate is a rate at which a probability that an ADC detector subsystem detection of the ion is a single ion event falls below a probability threshold level.

### Method for Combining ADC and Equivalent TDC Responses

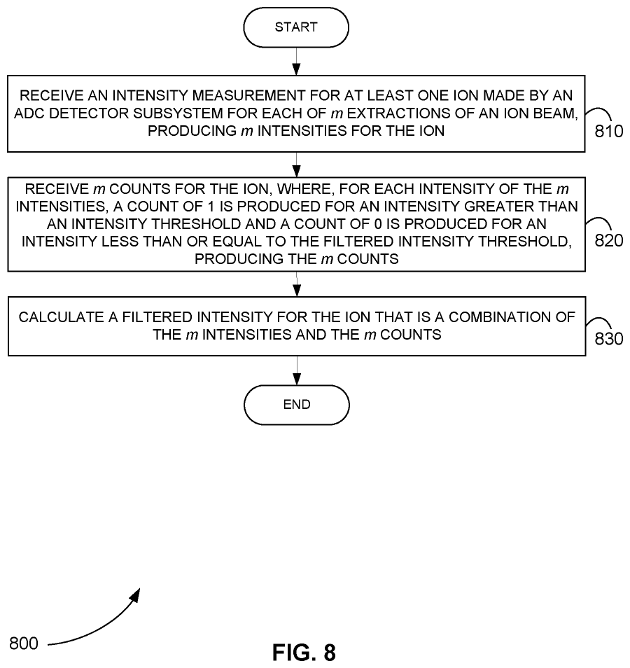

FIG. 8 is an exemplary flowchart showing a method 800 for filtering ion intensities measured by an ADC detector subsystem, in accordance with various embodiments.

In step 810 of method 800, an intensity measurement is received for at least one ion made by an ADC detector subsystem for each of m extractions of an ion beam, producing m intensities for the ion.

In step 820, m event realizations are received for the ion. For each intensity of the m intensities, an event realization of 1 is produced for an intensity greater than an intensity threshold and an event realization of less than 1, preferably 0 is produced for an intensity less than or equal to the filtered intensity threshold, producing the m event realizations.

In step 830, a filtered intensity is calculated for the ion that is a combination of the m intensities and the m event realizations.

### Computer Program Product for Combining ADC and Equivalent TDC Responses

In various embodiments, a computer program product includes a non-transitory tangible computer-readable storage medium whose contents include a program with instructions being executed on a processor so as to perform a method for filtering ion intensities measured by an ADC detector subsystem. This method is performed by a system that includes one or more distinct software modules.

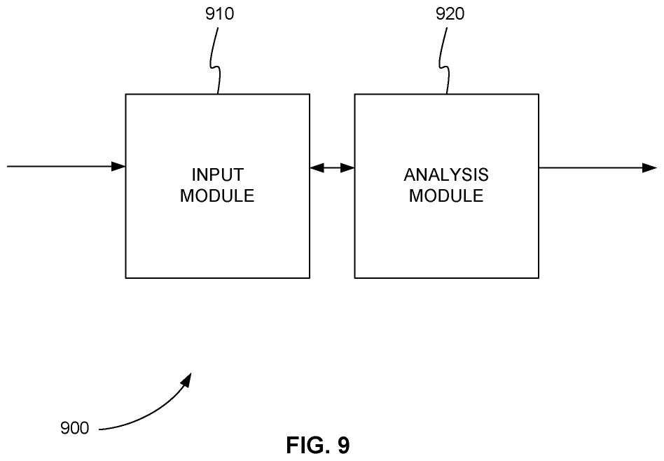

FIG. 9 is a schematic diagram of a system 900 that includes one or more distinct software modules and that performs a method for filtering ion intensities measured by an ADC detector subsystem, in accordance with various embodiments. System 900 includes input module 910 and analysis module 920.

Input module 910 receives an intensity measurement for at least one ion made by an ADC detector subsystem for each of m extractions of an ion beam, producing m intensities. Input module 910 receives m event realizations for the ion. For each intensity of the m intensities, an event realization of 1 is produced for an intensity greater than an intensity threshold and an event realization of less than 1, preferably 0 is produced for an intensity less than or equal to the filtered intensity threshold, producing the m event realizations.

Analysis module 920 calculates a filtered intensity for the ion that is a combination of the m intensities and the m event realizations.

### System for Obtaining TDC Event Realizations to the Nth Ion Event

Returning to FIG. 4, system 400 is used to filter in real-time ion intensities measured by an ADC detector subsystem, in accordance with various embodiments. Again, system 400 includes TOF mass analyzer 425 and processor 480. TOF mass analyzer 425 further includes ADC detector subsystem 470.

In system 400, processor 480 receives an intensity measurement Iᵢ for at least one ion made by an ADC detector subsystem for each ith extraction of m extractions of an ion beam. Again, one of ordinary skill in the art understands that receiving an intensity measurement Iᵢ for at least one ion is also equivalent to receiving an intensity measurement Iᵢ for a single m/z value. In other words, the terms “at least one ion” and “a single m/z value” are interchangeable as used herein.

Processor 480 obtains an equivalent TDC event realization for the ion. Specifically, for each Iᵢ of the ion from i=0, if Iᵢ is greater than an intensity threshold, processor 480 increments a total count of event realizations, T, by 1 until T equals a threshold count of event realizations, N, at an extraction, k. In various embodiments, initially, T=0. Processor 480 adds each Iᵢ from i=k+1 to i=m, producing summed intensity Iₛᵤₘ. Finally, processor 480 calculates a filtered intensity for the ion that is a combination of T and Iₛᵤₘ.

In various embodiments, the filtered intensity is calculated as a sum of T and Iₛᵤₘ.

In various embodiments, if T<N or k=m, the filtered intensity is T.

In various embodiments, processor 480 further calculates a corrected filtered intensity as −log(1−T/m).

In various embodiments, if k<m, the filtered intensity comprises N+Iₛᵤₘ.

In various embodiments, processor 480 further calculates a corrected filtered intensity as (Iₛᵤₘ−N)/(m−k)*m.

In various embodiments, Nis an event realization of ion events above which a probability that ADC detector subsystem 470 detection of the ion is a single ion event falls below a probability threshold level.

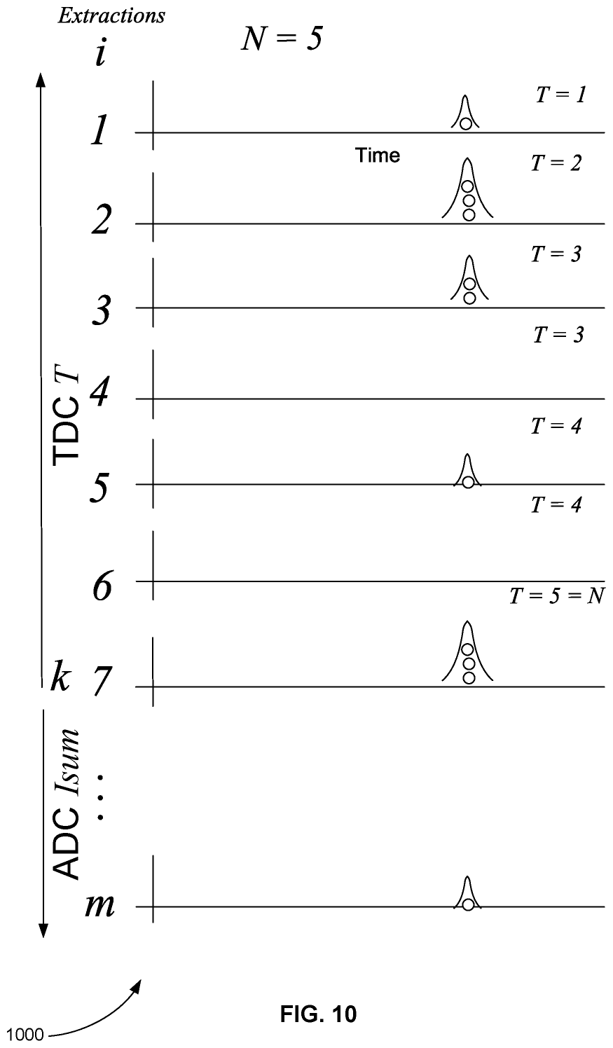

FIG. 10 is an exemplary plot 1000 of sub-spectra produced in a system to filter in real-time ion intensities measured by an ADC detector subsystem, in accordance with various embodiments. FIG. 10 shows how, for an m/z, an equivalent TDC event realization is accumulated for ion events up to a threshold count of event realizations, N. At the Nth ion event, the total count of equivalent TDC event realizations, T, is stored as metadata and the ADC intensities are accumulated for all remaining ion events. Specifically, in plot 1000, the threshold count of event realizations, N, is 5. The total count of event realizations, T, reaches the threshold count of event realizations, N, at extraction, k, where k=7. Thus, for extractions 1-7, the total count of equivalent TDC event realizations is stored.

For extractions 8-m, the ADC intensities, Iᵢ, are accumulated, producing summed intensity Iₛᵤₘ. The filtered intensity for the ion of plot 1000 is then a combination of T and Iₛᵤₘ, where T N.

### Method for Obtaining TDC Event Realizations to the Nth Ion Event

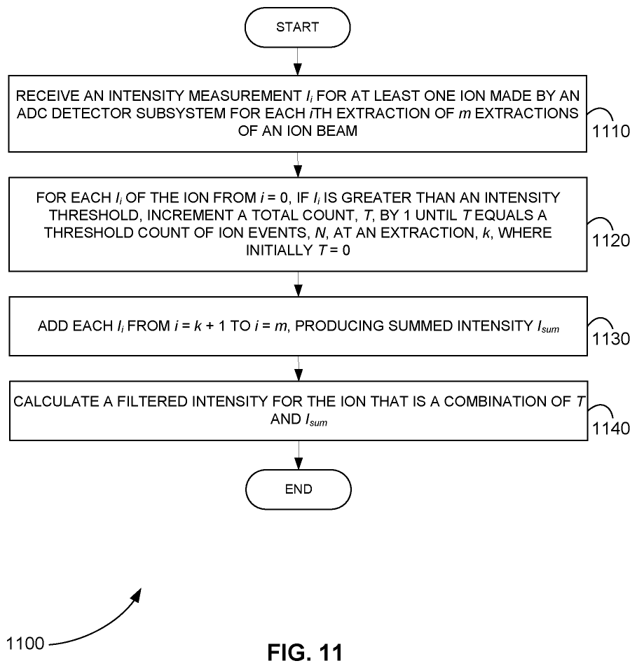

FIG. 11 is an exemplary flowchart showing a method 1100 for filtering in real-time ion intensities measured by an ADC detector subsystem, in accordance with various embodiments.

In step 1110 of method 1100, an intensity measurement Iᵢ is received for at least one ion made by an ADC detector subsystem for each ith extraction of m extractions of an ion beam.

In step 1120, for each Iᵢ of the ion from i=0, if Iᵢ is greater than an intensity threshold, a total count of event realizations, T, is incremented by 1 until T equals a threshold count of event realizations, N, at an extraction, k, optionally where initially T=0.

In step 1130, each Iᵢ from i=k+1 to i=m is added, producing summed intensity Iₛᵤₘ.

In step 1140, a filtered intensity is calculated for the ion that is a combination of T and Iₛᵤₘ.

### Computer Program Product for Obtaining TDC Event Realizations to the Nth Ion Event

In various embodiments, a computer program product includes a non-transitory tangible computer-readable storage medium whose contents include a program with instructions being executed on a processor so as to perform a method for filtering in real-time ion intensities measured by an ADC detector subsystem. This method is performed by a system that includes one or more distinct software modules.

Returning to FIG. 9, system 900 includes one or more distinct software modules and can also perform a method for filtering in real-time ion intensities measured by an ADC detector subsystem. System 900 includes input module 910 and analysis module 920.

Input module 910 receives an intensity measurement Iᵢ for at least one ion made by an ADC detector subsystem for each ith extraction of m extractions of an ion beam.

For each Iᵢ of the ion from i=0, if Iᵢ is greater than an intensity threshold, analysis module 920 increments a total count of event realizations, T, by 1 until T equals a threshold count of event realizations, N, at an extraction, k using the analysis module, where initially T=0. Analysis module 920 adds each Iᵢ from i=k+1 to i=m, producing summed intensity Iₛᵤₘ. Finally, analysis module 920 calculates a filtered intensity for the ion that is a combination of T and Iₛᵤₘ.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A method for filtering ion intensities measured by an analog-to-digital converter (ADC) detector subsystem, comprising:
receiving an intensity measurement for at least one ion made by an ADC detector subsystem for each of m extractions of an ion beam, producing m intensities for the ion;
receiving m event realizations for the ion, wherein, for each intensity of the m intensities, an event realization of 1 is produced for an intensity greater than an intensity threshold and an event realization of less than 1 is produced for an intensity less than or equal to the filtered intensity threshold, producing the m event realizations; and
calculating a filtered intensity for the ion that is a combination of the m intensities and the m event realizations.

2. The method of claim 1, wherein the event realization of less than 1 is 0.

3. The method of claim 1, wherein the filtered intensity is calculated as a weighted sum of the m intensities and the m event realizations.

4. The method of claim 3, wherein, when an ion rate of the ion is less than or equal to a threshold rate, a weight applied to the m event realizations is higher than a weight applied to the m intensities to reduce noise.

5. The method of claim 4, wherein, when the ion rate of the ion is greater than the threshold rate, the weight applied to the m event realizations is lower than the weight applied to the m intensities to increase dynamic range.

6. The method of claim 5, wherein the threshold rate is a rate at which a probability that an ADC detector subsystem detection of the ion is a single ion event falls below a probability threshold level.

7-11. (canceled)

12. A system for filtering ion intensities measured by an analog-to-digital converter (ADC) detector subsystem, comprising:
a processor that
receives an intensity measurement for at least one ion made by an ADC detector subsystem for each of m extractions of an ion beam, producing m intensities for the ion;
receives m event realizations for the ion, wherein, for each intensity of the m intensities, an event realization of 1 is produced for an intensity greater than an intensity threshold and an event realization of less than 1 is produced for an intensity less than or equal to the filtered intensity threshold, producing the m event realizations; and
calculates a filtered intensity for the ion that is a combination of the m intensities and the m event realizations.

13. The system of claim 12 wherein the event realization of less than 1 is 0.

14. The system of claim 12, wherein the filtered intensity is calculated as a weighted sum of the m intensities and the m event realizations.

15. The system of claim 14, wherein, when an ion rate of the ion is less than or equal to a threshold rate, a weight applied to the m event realizations is higher than a weight applied to the m intensities to reduce noise.

16. The system of claim 15, wherein, when the ion rate of the ion is greater than the threshold rate, the weight applied to the m event realizations is lower than the weight applied to the m intensities to increase dynamic range.

17. The system of claim 12, further comprising a memory device and wherein the processor receives the m intensities and m event realizations from the memory device and calculates the filtered intensity in a post-processing step.

18. The system of claim 12, further comprising a memory device and a time-of-flight (TOF) mass analyzer of a mass spectrometer and wherein the processor receives the m intensities and m event realizations from the TOF mass analyzer and calculates the filtered intensity in real-time during a sample acquisition by the mass spectrometer.

19. A method for filtering in real-time ion intensities measured by an analog-to-digital converter (ADC) detector subsystem, comprising:
receiving an intensity measurement Iᵢ for at least one ion made by an ADC detector subsystem for each ith extraction of m extractions of an ion beam;
for each Ii of the ion from i=0, if Iᵢ is greater than an intensity threshold, incrementing a total count of event realizations, T, by 1 until T equals a threshold count of event realizations, N, at an extraction, k;
adding each Ii from i=k+1 to i=m, producing summed intensity Iₛᵤₘ; and
calculating a filtered intensity for the ion that is a combination of T and Iₛᵤₘ.

20. The method of claim 19, wherein the filtered intensity is calculated as a sum of T and Iₛᵤₘ.

21. The method of claim 20, wherein, if T<N or k=m, the filtered intensity comprises T.

22. The method of claim 21, further comprising calculating a corrected filtered intensity as −log(1−T/m).

23. The method of claim 20, wherein, if k<m, the filtered intensity comprises N+Iₛᵤₘ.

24. The method of claim 23, further comprising calculating a corrected filtered intensity as (Iₛᵤₘ−N)/(m−k)*m.

25. The method of claim 19, wherein N is an event realization of ion events above which a probability that an ADC detector subsystem detection of the ion is a single ion event falls below a probability threshold level.

26-33. (canceled)
